(19) United States
(12) Patent Application Publication
(10) Pub. No.: US 2011/0113048 A1
(43) Pub. Date: May 12, 2011

(54) Enabling Faster Full-Text Searching Using a Structured Data Store

(76) Inventor: Hugh S. Njemanze, Redwood City, CA (US)

(21) Appl. No.: 12/942,890

(22) Filed: Nov. 9, 2010

Related U.S. Application Data
(60) Provisional application No. 61/259,479, filed on Nov. 9, 2009.

(51) Int. Cl. G06F 17/30

(52) U.S. Cl. 707/755; 707/E17.044

(57) ABSTRACT

A traditional structured data store is leveraged to provide the benefits of an unstructured full-text search system. A fixed number of “extended” columns is added to the traditional structured data store to form an “enhanced structured data store” (ESDS). The extended columns are independent of any regular columnar interpretation of the data and enable the data that they store to be searched using standard full-text query syntax/techniques that can be executed faster (as opposed to SQL syntax). In other words, the added columns act as a search index. A token is stored in an appropriate extended column based on that token's hash value. The hash value is determined using a hashing scheme, which operates based on the value of the token, rather than the meaning of the token. This enables subsequent searches to be expressed as full-text queries without degrading the ensuing search to a brute force scan.

### CROSS-REFERENCE TO RELATED APPLICATIONS

This application claims priority from U.S. Provisional Application Ser. No. 61/259,479, filed Nov. 9, 2009, entitled “Enabling Full-Text Searching Using a Structured Data Store” and is related to U.S. patent application Ser. No. 12/554,541, entitled “Storing Log Data Efficiently While Supporting Querying,” filed Sep. 4, 2009, and U.S. patent application Ser. No. 11/966,078, entitled “Storing Log Data Efficiently While Supporting Querying to Assist in Computer Network Security,” filed Dec. 28, 2007, all three of which are incorporated by reference herein in their entirety.

### BACKGROUND

1. Field of Art

This application generally relates to full-text searching and structured data stores. More particularly, it relates to enabling faster full-text searching using a structured data store.

2. Description of the Related Art

Generally, document or data storage systems independently address the problems of searching unstructured data and searching structured data, implementing one or both of a full-text index system or a database system according to whether the priority is on unstructured search (like a Google search engine) or structured search (like an Oracle database), respectively. A system that implements both can provide the features of both but at the cost of paying both the performance penalties incurred in preparing each of these repositories (and their associated indexes) and the separate storage overhead. The typical trade-off is to implement only one and suffer slow query time performance for the types of queries that are better suited to the other system.

### SUMMARY

A traditional structured data store is leveraged to additionally provide many of the benefits of an unstructured full-text search system, thereby avoiding the overhead of preparing the data in two distinct indexes/repositories with the attendant storage overhead and insertion performance penalties. Columns that are independent of any regular columnar interpretation of the data are added to the traditional structured data store, thereby creating an “enhanced structured data store” (ESDS). The added columns enable the data that they store to be searched using standard full-text query syntax/techniques that can be executed at full speed (as opposed to standard database management system (DBMS) facilities such as “like” clauses in SQL queries). In other words, the added columns act as a search index.

A fixed number of “extended” columns is added to the traditional structured data store to form the enhanced structured data store (ESDS). The data for which faster full-text searching is to be enabled is parsed into tokens (e.g., words). Each token is stored in an appropriate extended column based on that token's hash value. The hash value is determined using a hashing scheme, which operates based on the value of the token, rather than the meaning of the token (where the meaning is based on the “column” or “field” that the token would normally correspond to in a structured data store). This enables subsequent searches to be expressed as full-text queries without degrading the ensuing search to a brute force scan across a single blob field or across each and every column.

Any hashing scheme can be used. Different hashing schemes will result in different levels of performance (e.g., different search speeds) based on the statistical distribution of the data that is being stored. In one embodiment, the hashing scheme uses a character from the token itself (i.e., from the value of the token) as the hash value. In another embodiment, a token's hash value is determined based on the length of the token (i.e., the number of characters). In yet another embodiment, the token's length attribute is combined with another attribute (e.g., a character from the token) to determine the hash value.

When a user queries the enhanced structured data store (ESDS), he can use standard full-text query syntax. For example, the user can enter “fox” as the query. The query “fox” is translated into standard database query syntax (e.g., Structured Query Language or “SQL”) based on the hashing scheme being used. For example, if the hashing scheme uses a token's first character as the token's hash value, then “fox” will be translated into SQL for “where field F=‘fox’” or SQL for “where field F contains ‘fox’”. If the hashing scheme uses a token's second character as the token's hash value, then “fox” will be translated into SQL for “where field O=‘fox’” or SQL for “where field O contains ‘fox’”.

The extended fields can support phrase searches directly. A string is parsed into tokens, and each individual token is stored in an extended field. In addition to these “standard” tokens, additional tokens are also stored in the extended fields. For example, each pair of tokens that appears in string is also stored in phrase-order in an appropriate extended field and, therefore, is available for searching. In one embodiment, a token pair includes a first token and a second token that are separated by a special character (e.g., the underscore character “_”). The_character indicates that the first token and the second token appear in the string in that order and are adjacent to each other. Both individual tokens and token pairs can be stored in the extended fields. The extended fields can also support “begins with” and “ends with” searches directly by storing additional tokens that use special characters to indicate additional information about the standard tokens, such as whether the standard token is the first token in a string or the last token in a string.

The techniques described above (e.g., storing tokens in extended fields based on their values and a hashing scheme) can be used with any structured data store. For example, the technique can be used with a row-based database management system (DBMS). However, the technique is particularly well suited to a column-based DBMS. A column-based DBMS is advantageous because the technique narrows a query down to a specific column (extended field) that must contain a given search term (even though the end user does not specify a column at all). The other fields of the rows need not be examined (or even loaded) in order to determine a result.

### BRIEF DESCRIPTION OF DRAWINGS

FIG. 1 shows an example of an event description and how that event description can be represented in an enhanced structured data store, according to one embodiment of the invention.

FIG. 2 is a block diagram of a system that enables faster full-text searching using an enhanced structured data store, according to one embodiment of the invention.

FIG. 3 is a flowchart of a method for storing event information in an enhanced structured data store, according to one embodiment of the invention.

FIG. 4 is a flowchart of a method for performing a full-text search on event information stored in an enhanced structured data store, according to one embodiment of the invention.

### DETAILED DESCRIPTION

The features and advantages described in the specification are not all inclusive and, in particular, many additional features and advantages will be apparent to one of ordinary skill in the art in view of the drawings, specification, and claims. The language used in the specification has been principally selected for readability and instructional purposes and may not have been selected to delineate or circumscribe the disclosed subject matter.

The figures and the following description relate to embodiments of the invention by way of illustration only. Alternative embodiments of the structures and methods disclosed here may be employed without departing from the principles of what is claimed.

Reference will now be made in detail to several embodiments, examples of which are illustrated in the accompanying figures. Wherever practicable, similar or like reference numbers may be used in the figures and may indicate similar or like functionality. The figures depict embodiments of the disclosed systems (or methods) for purposes of illustration only. One skilled in the art will readily recognize from the following description that alternative embodiments of the structures and methods illustrated herein may be employed without departing from the principles described herein.

As used herein, the term “structured data” refers to data that has a defined structure to its elements or atoms. One example of structured data is a row that is stored in a relational database. Another example of structured data is a row of a spreadsheet where a cell in a particular column always stores a particular type of data (e.g., a cell in column A always stores an address, and a cell in column B always stores a Social Security number). A text file is usually unstructured data because the document indicates nothing about the significance of any given word other than what can be inferred by looking at the word itself. In other words, there is no metadata about the data, just the data itself. However, if markup is added (such as a <verb> tag before every verb), then the document would have some structure. Having a schema is another way to impose structure.

As used herein, the term “structured data store” refers to a data store that has columns and data types for the columns (i.e., a schema). The data stored in the structured data store is consistently organized into the appropriate columns. One example of a structured data store is a relational database. Another example of a structured data store is a spreadsheet.

In one embodiment, a traditional structured data store is leveraged to additionally provide many of the benefits of an unstructured full-text search system, thereby avoiding the overhead of preparing the data in two distinct indexes/repositories with the attendant storage overhead and insertion performance penalties. Columns that are independent of any regular columnar interpretation of the data are added to the traditional structured data store, thereby creating an “enhanced structured data store” (ESDS). The added columns enable the data that they store to be searched using standard full-text query syntax/techniques that can be executed at full speed (as opposed to standard database management system (DBMS) facilities such as “like” clauses in SQL queries). In other words, the added columns act as a search index.

The data for which full-text searching is to be enabled can be stored in various ways. One option is to store all of the data in one added column as a single blob (binary large object). The value in this field can then be searched. However, full-text searches using this approach will be time-consuming.

Another option is to parse the data into tokens (e.g., words) and store each token in its own added column. This way, the data will be spread out among several columns instead of being stored in a single column as a blob. One problem with this approach is that the number of added columns will vary based on the content and/or format of the data (specifically, the number of tokens in the data). Also, full-text searches using this approach will be time-consuming.

In one embodiment, a fixed number of “extended” columns is added to the traditional structured data store to form the enhanced structured data store (ESDS). Each token is stored in an appropriate extended column based on that token's hash value. The hash value is determined using a hashing scheme, which operates based on the value of the token, rather than the meaning of the token (where the meaning is based on the “column” or “field” that the token would normally correspond to in a structured data store). This enables subsequent searches to be expressed as full-text queries without degrading the ensuing search to a brute force scan across a single blob field or across each and every column.

### EXAMPLE

Consider a traditional structured data store that stores an “event” (“document” in full-text parlance or “row” in DBMS parlance) using only four “base” fields: a timestamp field, a count field, an incident description field, and an error description field. In order to store an event in the traditional structured data store, a timestamp value, a count value, an incident description value, and an error description value are extracted from the event description or determined based on information contained within the event description. The timestamp value, the count value, the incident description value, and the error description value are then stored in the timestamp field, the count field, the incident description field, and the error description field, respectively, of an entry in the traditional structured data store. The timestamp value, the count value, the incident description value, and the error description value can then be accessed or queried. Since the timestamp value, the count value, the incident description value, and the error description value are stored, they can be subjected to a full-text search. However, the full-text search will require a brute force search, since no search index exists.

Now, the traditional structured data store is enhanced in order to support faster full-text searching of the event information. Specifically, 36 extended fields are added to the 4 existing base fields (timestamp, count, incident description, and error description, as explained above) in order to create an enhanced structured data store (ESDS). The ESDS thus stores an event using 40 fields: 4 base fields and 36 extended fields. The base fields store structured data, based on the data's meaning. The extended fields store event tokens, based on each token's value. In the illustrated embodiment, one extended field is included for each letter of the alphabet (A through Z, for a total of 26 alphabetical fields) and for each digit (0 through 9, for a total of 10 numerical fields), for a grand total of 36 extended fields. In other words, an event is stored using 40 fields: Timestamp, Count, Incident Description, Error Description, A, B, . . . , Y, Z, 0, 1, . . . , 8, 9.

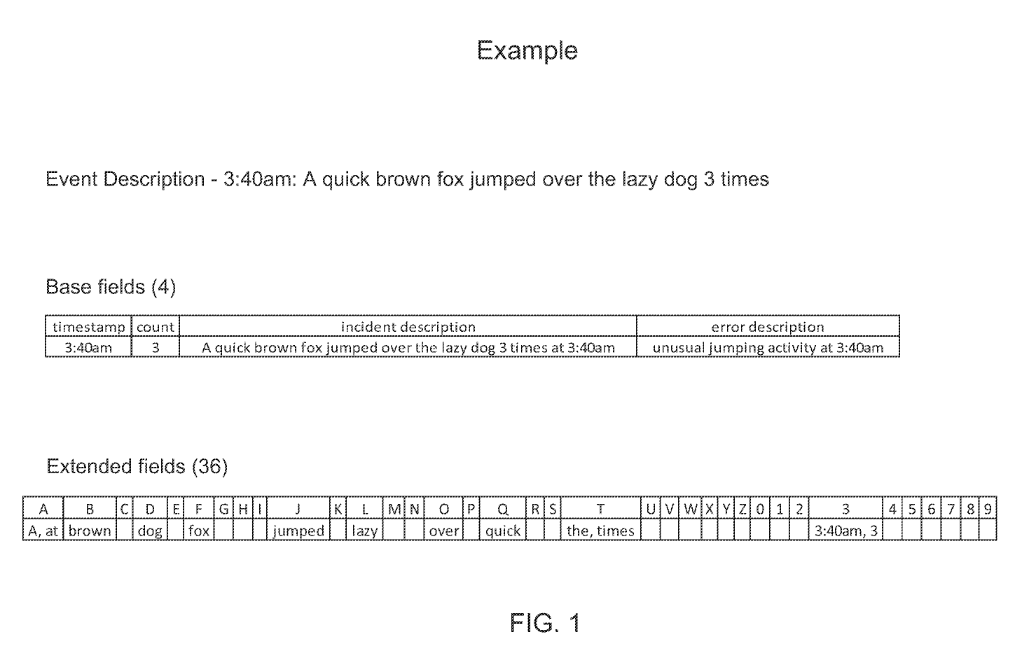

FIG. 1 shows an example of an event description and how that event description can be represented in an enhanced structured data store, according to one embodiment of the invention. In FIG. 1, the event reads as follows:

3:40 am: A quick brown fox jumped over the lazy dog 3 times
In order to store the event information in the ESDS, the event is parsed into tokens. The “structured” data is extracted from the event description (or determined based on information contained within the event description) and stored in the base fields. The portion of the event information that is desired to be indexed (i.e., enabled for faster full-text searching) is identified. This portion can be, for example, a value that is stored in a base field or the entire event description. The tokens of that portion are stored in the extended fields (search index) and are therefore capable of being full-text searched in a faster manner. Note that one token can be stored twice—once in a base field and once in an extended field.

In the illustrated example, the timestamp value (3:40 am), the count value (3), the incident description value (A quick brown fox jumped over the lazy dog 3 times at 3:40 am), and the error description value (unusual jumping activity at 3:40 am) are extracted from the event description (or determined based on information contained within the event description) and stored in the timestamp base field, the count base field, the incident description base field, and the error description base field, respectively. Assume that only the incident description value is desired to be enabled for high-speed full-text searching. The incident description value is parsed into 13 tokens, namely: 1) A, 2) quick, 3) brown, 4) fox, 5) jumped, 6) over, 7) the, 8) lazy, 9) dog, 10) 3, 11) times, 12) at, and 13) 3:40 am. Each of the 13 tokens is stored in an extended field according to that token's hash value.

Assume that the hashing scheme selects the first character of the token as the hash value of that token. The token is then stored in the appropriate extended field. Token 1 (“A”) would have a hash value of “A” and therefore be stored in the “A” field, token 2 (“quick”) would have a hash value of “Q” and therefore be stored in the “Q” field, token 3 (“brown”) would have a hash value of “B” and therefore be stored in the “B” field, and so on. FIG. 1 shows how the event information can be represented in an enhanced structured data store that uses the above-described 40 fields (4 base fields and 36 extended fields) and first-character hashing scheme and that enables the incident description value to be full-text searched in a faster manner.

Note that token 1 (“A”) and token 2 (“quick”) are each stored twice—once in a base field (incident description) and once in an extended field (“A” and “Q”, respectively). Also, token 1 (“A”) and token 12 (“at”) have the same hash value (“A”) and thus are both stored in the same field (“A”).

Now, assume that both the incident description value and the error description value are desired to be enabled for high-speed full-text searching. Tokens from these values are stored in the appropriate extended fields. Note that only one set of extended fields (e.g., 36 extended fields) is necessary to store the tokens, even though tokens from two different values (the incident description value and the error description value) are being stored.

For example, FIG. 1 shows how the tokens of the incident description value are stored in the extended fields. If the error description value is also desired to be enabled for high-speed full-text searching, then the value is parsed into 5 tokens (“unusual”, “jumping”, “activity”, “at”, and “3:40 am”), and those tokens are stored in the extended fields. The “unusual” token would have a hash value of “U” and therefore be stored in the “U” extended field, and so on.

Recall that the incident description value was already enabled for high-speed full-text searching. This caused the “at” token (from within the incident description value) to be stored in the “A” extended field. The error description value also includes the token “at”. In one embodiment, the extended fields indicate presence or absence of a token in an event as a whole (e.g., in all portions of the event that are enabled for high-speed searching). In this embodiment, a token will be stored only once per event, even if that token appears multiple times in the event. So, in this embodiment, the token “at” would be stored only once, even though the token “at” appears in both the incident description value and the error description value.

Note that a token pair, discussed below in conjunction with phrase searching, might include a token that has already been stored. For example, the token pairs “times_at” and “at_{—}3:40 am” (from the incident description value) might be stored in addition to the token “at”. As another example, the token pair “activity_at” (from the error description value) might be also be stored. The token pair “at_{—}3:40 am” (from the error description value) would not be stored, in the above-described embodiment, because it was already stored in conjunction with the token pair “at_{—}3:40 am” (from the incident description value).

A search query might indicate that a token must appear within a particular base field. In this situation, events that contain that token anywhere (e.g., in any base field of the event that has been enabled for high-speed full-text searching), can be subjected to further processing based on exactly where the token is within the event. For example, an event can be eliminated from a set of search results if that event does not contain the token within the particular base field.

### System

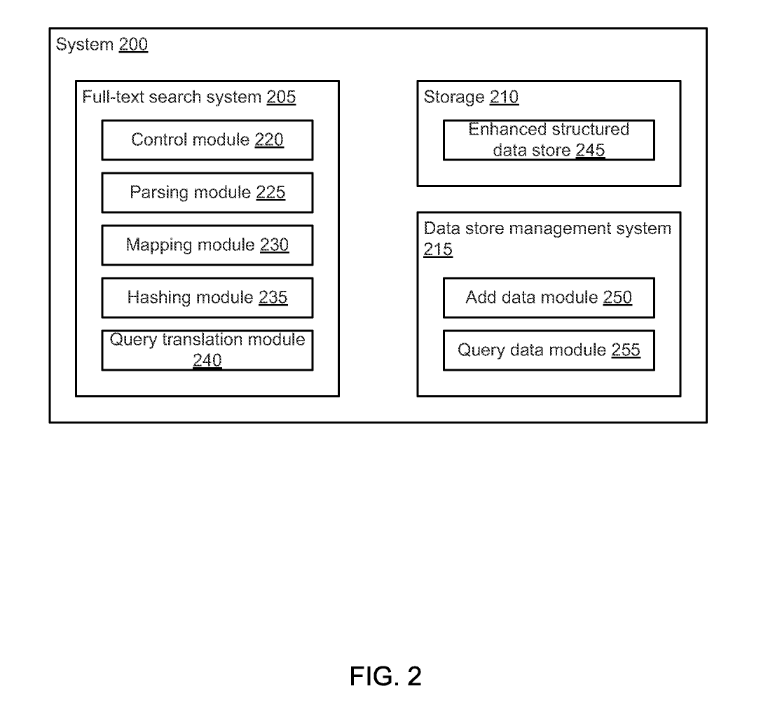

FIG. 2 is a block diagram of a system that enables faster full-text searching using an enhanced structured data store, according to one embodiment of the invention. The system 200 is able to perform a faster full-text search on event information that is stored in an enhanced structured data store (ESDS) (specifically, on event information that is stored in the extended fields of the ESDS). The illustrated system 200 includes a full-text search system 205, storage 210, and a data store management system 215.

In one embodiment, the full-text search system 205 and the data store management system 215 (and their component modules) are one or more computer program modules stored on one or more computer readable storage mediums and executing on one or more processors. The storage 210 (and its contents) is stored on one or more computer readable storage mediums. Additionally, the full-text search system 205 and the data store management system 215 (and their component modules) and the storage 210 are communicatively coupled to one another to at least the extent that data can be passed between them.

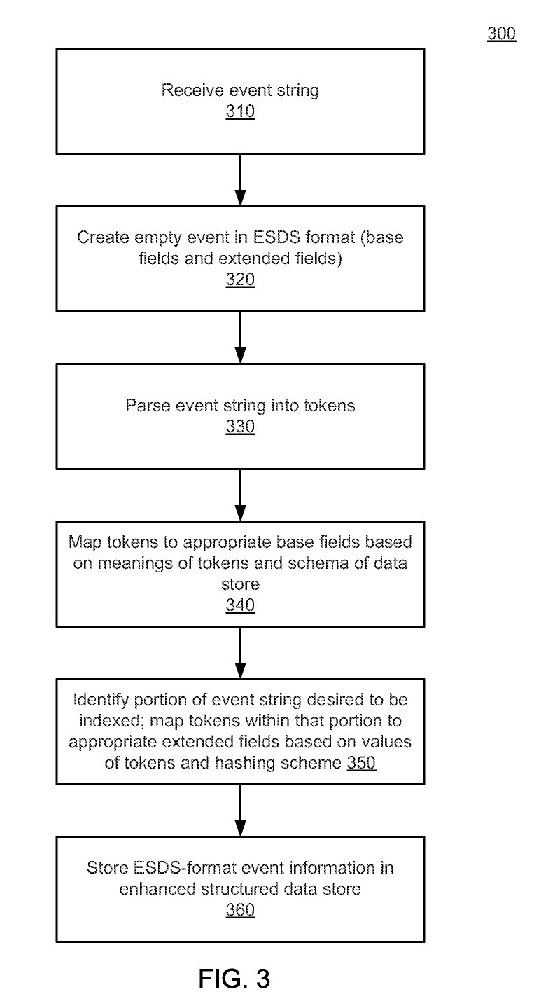

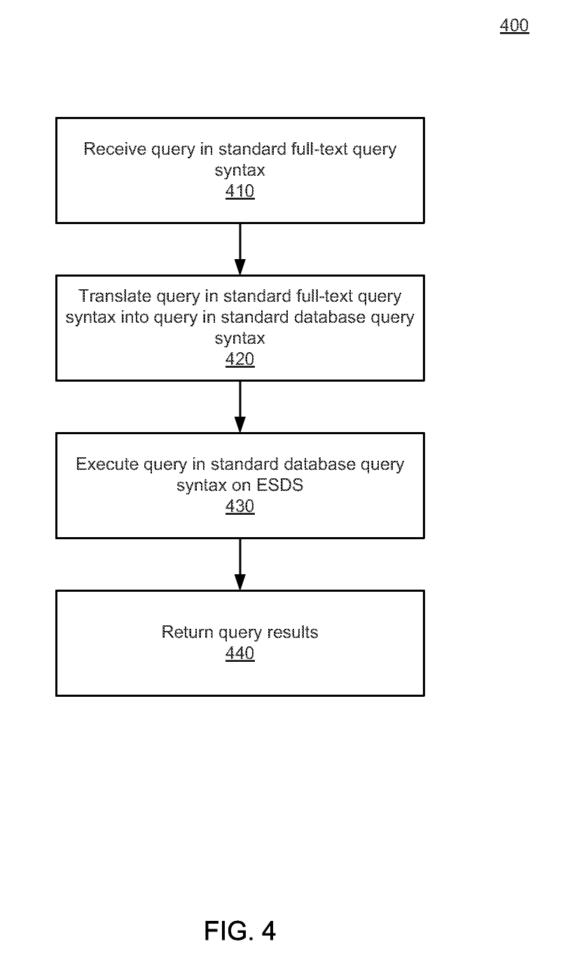

The full-text search system 205 includes multiple modules, such as a control module 220, a parsing module 225, a mapping module 230, a hashing module 235, and a query translation module 240. The control module 220 controls the operation of the full-text search system 205 (i.e., its various modules) so that the full-text search system 205 can store event information in an enhanced structured data store (ESDS) 245 and perform a faster full-text search on the event information that is stored in the extended fields of the ESDS. The operation of control module 220 will be discussed below with reference to FIG. 3 (storage) and FIG. 4 (search).

The parsing module 225 parses a string into tokens based on delimiters. Delimiters are generally divided into two groups: “white space” delimiters and “special character” delimiters. White space delimiters include, for example, spaces, tabs, newlines, and carriage returns. Special character delimiters include, for example, most of the remaining non-alphanumeric characters such as a comma (“,”) or a period (“.”). In one embodiment, the delimiters are configurable. For example, the white space delimiters and/or the special character delimiters can be configured based on the data that is being parsed (e.g., the data's syntax).

In one embodiment, the parsing module 225 splits a string into tokens based on a set of delimiters and a trimming policy (referred to as “tokenization”). In one embodiment, the default delimiter set is {“, ‘\n’, ‘\r’, ‘,’, ‘\t’, ‘‘=’, ‘|’, ‘,’, ‘[’, ‘]’, ‘(’, ‘)’, ‘<’, ‘>’, ‘{’, ‘}’, ‘#’, ‘\“,” “, ‘0’}, and the default trimming policy is to ignore special characters (other than {‘/’, ‘−’, ‘+’}) that occur at the beginning or end of a token. Delimiters can be either static or context-sensitive. Examples of context sensitive delimiters are {‘:’, ‘/’} which are considered delimiters only when they follow what looks like an IP address. This is to handle a combination of an IP address and a port number, such as 10.10.10.10/80 or 10.10.10.10:80, which is common in events. If these characters were included in the default delimiter set, then file names and URLs would be split into multiple tokens, which might be inaccurate. Any contiguous string of untrimmed non-delimiter characters is considered to be a token. In one embodiment, the parsing module 225 uses a finite state machine (rather than regular expressions) for performance reasons.

In general, any parser/tokenizer can be used to split a string into tokens based on a set of delimiters and a trimming policy. One example of a publicly available tokenizer is java.util.StringTokenizer, which is part of the Java standard library. StringTokenizer uses a fixed delimiter string of one or more characters (e.g., the whitespace character) to split a string into multiple strings. The problem with this approach is the inflexibility of using the same delimiter regardless of context. Another approach is to use a list of known regular expression patterns and identify the matching portions of the string as tokens. The problem with this approach is performance.

The mapping module 230 extracts structured data from an event description (e.g., a string) and stores the data in the appropriate base field(s). The mapping module is similar to existing technology that extracts a particular value from an event description and uses the extracted value to populate a field in a normalized schema. The values that are stored in the base fields can have various data types, such as a timestamp, a number, an internet protocol (IP) address, or a string. Note that some data might not be stored in any of the base fields.

The hashing module 235 determines a hash value for a particular token. This hash value indicates which extended field in the enhanced structured data store (ESDS) 245 should be used to store that particular token. The hash value is determined according to a hashing scheme. The hashing scheme operates based on the value of the token, rather than the meaning of the token (where the meaning is based on the “column” or “field” that the token would normally correspond to in a structured data store). The token's value is stored in the appropriate extended field as a string.

One example of such a hashing scheme is to use a character from the token (i.e., from the value of the token) as the hash value. If the character is a letter, then the token can have any one of 26 hash values (one for each letter of the alphabet, A through Z). The token would then be stored in one of 26 extended fields (one for each letter of the alphabet, A through Z). If the character is a number, then the token can have any one of 10 hash values (one for each digit, 0 through 9). The token would then be stored in one of 10 extended fields (one for each digit, 0 through 9). If the character can be either a letter or a number, then the token can have any one of 36 hash values (one for each letter of the alphabet, A through Z, and one for each digit, 0 through 9). The token would then be stored in one of 36 extended fields (one for each letter of the alphabet, A through Z, and one for each digit, 0 through 9). If the character can be something other than a letter or a number (i.e., non-alphanumeric), then an additional catchall hash value (“Other”) and extended field (“Other”) can be used.

The character that is used as the hash value can be, for example, the first character of the token, the second character of the token, or the last character of the token. If the hashing scheme uses the second character and the token is only character, then a particular character is used (e.g., the space “ ” character).

In addition to hashing schemes that use a character from the token itself as already described, there are additional approaches and refinements that can be used. For example, the hash value (and, therefore, the appropriate extended field) can be determined based on the length of the token (i.e., the number of characters). For example, consider a hashing scheme that uses the length of a token as that token's hash value. Tokens from the following string:

A quick brown fox jumped over the lazy dog 3 times at 3:40 am
would have the following hash values:

TABLE 1
Tokens and hash values

| Token | Hash Value |
|---|---|
| A | 1 |
| quick | 5 |
| brown | 5 |
| fox | 3 |
| jumped | 6 |
| over | 4 |
| the | 3 |
| lazy | 4 |
| dog | 3 |
| 3 | 1 |
| times | 5 |
| at | 2 |
| 3:40 am | 6 |

In this example, one extended field would be present for each hash value (1, 2, 3, etc.). The tokens would be stored in the extended fields as follows:

TABLE 2
Extended fields and tokens

| Extended Field | Token(s) |
|---|---|
| 1 | A, 3 |
| 2 | at |
| 3 | the, fox, dog |
| 4 | lazy, over |
| 5 | quick, brown, times |
| 6 | jumped, 3:40 am |
| 7 | |
| 8 | |
| 9 | |
| 10 | |

A hashing scheme that uses a token's length as that token's hash value will cluster most tokens into a small number of extended fields. However, if the token's length attribute is combined with another attribute (e.g., a character from the token), then the distribution characteristics of the hashing scheme will improve. For example, consider a hashing scheme that uses both the length of a token and a character from the token as that token's hash value. Tokens from the following string:

A quick brown fox jumped over the lazy dog 3 times at 3:40 am
would have the following hash values, where the first part of the hash value (i.e., before the hyphen) is the length, and the second part of the hash value (i.e., after the hyphen) is the first character:

TABLE 3
Tokens and hash values

| Token | Hash Value |
|---|---|
| A | 1-a |
| quick | 5-q |
| brown | 5-b |
| fox | 3-f |
| jumped | 6-j |
| over | 4-o |
| the | 3-t |
| lazy | 4-l |
| dog | 3-d |
| 3 | 1-3 |
| times | 5-t |
| at | 2-a |
| 3:40 am | 6-3 |

According to this hashing scheme, enabling 10 different lengths (1 through 9 and 10 for all lengths above 9) and 36 different characters (26 letters and 10 digits) results in 360 (10×36) possible hash values: 1-a, 1-b, . . . , 1-y, 1-z, 1-0, 1-1, . . . , 1-8, 1-9, 2-a, 2-b, . . . , 2-y, 2-z, 2-0, 2-1, . . . , 2-8, 2-9, 3-a, etc.

One extended field would be present for each hash value, for a total of 360 extended fields. The tokens would be stored in the extended fields as follows: (Extended fields that do not store any tokens are omitted in order to save space.)

TABLE 4
Extended fields and tokens

| Extended Field | Token(s) |
|---|---|
| 1-a | A |
| 1-3 | 3 |
| 2-a | at |
| 3-d | dog |
| 3-f | fox |
| 3-t | the |
| 4-l | lazy |
| 4-o | over |
| 5-b | brown |
| 5-q | quick |
| 5-t | times |
| 6-j | jumped |
| 6-3 | 3:40 am |

If 360 distinct hash values (and, thus, 360 extended fields) are deemed to be too many, then the number can be reduced by, for example, reducing the number of length “categories”. Using only 5 length categories (e.g., length 1 to 2, length 3 to 4, length 5 to 6, length 7 to 8, and length 9+) would result in a total of 180 distinct hash values (and, thus, 180 extended fields) (5×36). For example, tokens from the following string:

A quick brown fox jumped over the lazy dog 3 times at 3:40 am
would have the following hash values, where the first part of the hash value (i.e., before the hyphen) is the length category (“1” for 1 to 2, “2” for 3 to 4, etc.), and the second part of the hash value (i.e., after the hyphen) is the first character:

TABLE 5
Tokens and hash values

| Token | Hash Value |
|---|---|
| A | 1-a |
| quick | 3-q |
| brown | 3-b |
| fox | 2-f |
| jumped | 3-j |
| over | 2-o |
| the | 2-t |
| lazy | 2-l |
| dog | 2-d |
| 3 | 1-3 |
| times | 3-t |
| at | 1-a |
| 3:40 am | 3-3 |

The tokens would be stored in the extended fields as follows: (Extended fields that do not store any tokens are omitted in order to save space.)

TABLE 6
Extended fields and tokens

| Extended Field | Token(s) |
|---|---|
| 1-a | A, at |
| 1-3 | 3 |
| 2-d | dog |
| 2-f | fox |
| 2-l | lazy |
| 2-o | over |
| 2-t | the |
| 3-b | brown |
| 3-j | jumped |
| 3-q | quick |
| 3-t | times |
| 3-3 | 3:40 am |

Another way to reduce the number of distinct hash values (and, thus, the number of extended fields) is to reduce the number of character “categories”. Using only 27 character categories (e.g., A, B, . . . , Y, Z, and “digit” for all 10 digits) would result in a total of 270 distinct hash values (and, thus, 270 extended fields) (10×27). For example, tokens from the following string:

A quick brown fox jumped over the lazy dog 3 times at 3:40 am
would have the following hash values, where the first part of the hash value (i.e., before the hyphen) is the length (1, 2, etc.), and the second part of the hash value (i.e., after the hyphen) is the first character (specific letter or “digit” for any digit):

TABLE 7
Tokens and hash values

| Token | Hash Value |
|---|---|
| A | 1-a |
| quick | 5-q |
| brown | 5-b |
| fox | 3-f |
| jumped | 6-j |
| over | 4-o |
| the | 3-t |
| lazy | 4-l |
| dog | 3-d |
| 3 | 1-digit |
| times | 5-t |
| at | 2-a |
| 3:40 am | 6-digit |

The tokens would be stored in the extended fields as follows: (Extended fields that do not store any tokens are omitted in order to save space.)

TABLE 8
Extended fields and tokens

| Extended Field | Token(s) |
|---|---|
| 1-a | A |
| 1-digit | 3 |
| 2-a | at |
| 3-d | dog |
| 3-f | fox |
| 3-t | the |
| 4-l | lazy |
| 4-o | over |
| 5-b | brown |
| 5-q | quick |
| 5-t | times |
| 6-j | jumped |
| 6-digit | 3:40 am |

Using only 5 length categories and 27 character categories would result in a total of 135 distinct hash values (and, thus, 135 extended fields) (5×27). For example, tokens from the following string:

A quick brown fox jumped over the lazy dog 3 times at 3:40 am
would have the following hash values, where the first part of the hash value (i.e., before the hyphen) is the length category (“1” for 1 to 2, “2” for 3 to 4, etc.), and the second part of the hash value (i.e., after the hyphen) is the first character (specific letter or “digit” for any digit):

TABLE 9
Tokens and hash values

| Token | Hash Value |
|---|---|
| A | 1-a |
| quick | 3-q |
| brown | 3-b |
| fox | 2-f |
| jumped | 3-j |
| over | 2-o |
| the | 2-t |
| lazy | 2-l |
| dog | 2-d |
| 3 | 1-digit |
| times | 3-t |
| at | 1-a |
| 3:40 am | 3-digit |

The tokens would be stored in the extended fields as follows: (Extended fields that do not store any tokens are omitted in order to save space.)

TABLE 10
Extended fields and tokens

| Extended Field | Token(s) |
|---|---|
| 1-a | A, at |
| 1-digit | 3 |
| 2-d | dog |
| 2-f | fox |
| 2-l | lazy |
| 2-o | over |
| 2-t | the |
| 3-b | brown |
| 3-j | jumped |
| 3-q | quick |
| 3-t | times |
| 3-digit | 3:40 am |

Characters that are encoded according to the Unicode standard can also be supported. If a character is encoded using 16-bit Unicode, then 2¹⁶ (65,536) different characters are possible. A hashing scheme could determine a token's hash value by selecting a (Unicode) character from the token and then masking off some part of the character. For example, the “least interesting” 8 bits of a 16-bit Unicode character could be masked off (e.g., the bits that typically do not change because a) no characters have been assigned to them in the Unicode standard or b) they are not typically used in the language(s) in which the tokens are expressed). For example, for Western languages, the low-order 8 bits would be the interesting ones because they essentially use the ASCII subset as part of the Unicode encoding.

If 256 extended fields are used to store tokens that contain 16-bit Unicode characters, then each extended field could potentially store tokens with up to 256 different “hash characters”, where a hash character is a character that determines in which extended field to store a token (i.e., a hash value). If, instead, only 128 extended fields are used to store tokens that contain 16-bit Unicode characters, then each extended field could potentially store tokens with up to 512 different hash characters (hash values). Even though 512 different hash values map to one extended field, the hashing is still beneficial when executing a search query, as long as the token distribution is fairly even. In particular, note that the 127 other extended fields are eliminated from consideration before the search is begun. In other words, using 128 (or 256) extended fields in which to store tokens results in search query execution that is approximately 100 times faster than using only 1 extended field in which to store tokens.

Unicode example—Consider the following Unicode bit pattern:

[0000 0000 0100 1011]
and the “key” (hash value):
[0100 1011]
In this example, any token whose hash character (i.e., hash value) is one of the 256 possible Unicode characters that end in [0100 1011] would be stored in column [0100 1011].

Any hashing scheme can be used. Different hashing schemes will result in different levels of performance (e.g., different search speeds) based on the statistical distribution of the data that is being stored. In one embodiment, different hashing schemes are tested with the typical distribution of data. The hashing scheme that results in the best performance is then selected.

In general, the best hashing scheme for a particular situation is the scheme that distributes the tokens most evenly over the various extended fields. The number of extended fields can be, for example, anywhere between around 10 to around a few hundred fields, depending on the implementation scenario. In general, when selecting a hashing scheme, the idea is to first decide how many extended fields are practical. Then, select a hashing scheme that distributes the data (e.g., tokens) evenly into the various extended fields.

Additional considerations include the fact that a particular arrangement of extended fields can enable, simplify, or optimize the performance of new search operators. New search operators, and their associated extended fields, are discussed below in conjunction with the query translation module 240.

The hashing scheme might result in multiple tokens being mapped to the same extended field. If the ESDS does not support multi-valued fields, then a single value of the multiple tokens (appended together with delimiters to separate them) would be stored. If the ESDS does support multi-valued fields, then the multiple tokens would be stored as multiple independent values in the same field. In one embodiment, when multiple tokens are mapped to the same field, they are stored in sorted order so that a determination that a query term is not a match can be made as soon as a lexically higher token has been encountered.

Stopwords can be used so that, for example, a token like “the” does not tie up the “T” field (assuming that the hashing scheme uses the initial character as the hash value). Additionally, known full-text indexing techniques can be applied in combination with these ideas, such as performing stem truncation on tokens before hashing them so that, for example, the token “baby” and the token “babies” would result in the same hash value (and, thus, be stored in the same extended field).

The query translation module 240 translates a search query in standard full-text query syntax to a search query in standard database query syntax (e.g., Structured Query Language or “SQL”). When a user queries the enhanced structured data store (ESDS) 245, he can use standard full-text query syntax. For example, the user can enter “fox” as the query. The query translation module 240 will translate “fox” into standard database query syntax (e.g., SQL) based on the hashing scheme being used. For example, if the hashing scheme uses a token's first character as the token's hash value, then “fox” will be translated into SQL for “where field F=‘fox’” or SQL for “where field F contains ‘fox’”. If the hashing scheme uses a token's second character as the token's hash value, then “fox” will be translated into SQL for “where field O=‘fox’ or SQL for “where field O contains ‘fox’”.

Boolean logic in search queries is transparently supported. The query translation module 240 translates the Boolean logic into database logic (e.g., column logic). For example, the query “fox or dog” will be translated into “F=‘fox’ or D=‘dog’” (assuming the hashing scheme uses the initial character as the hash value). As another example, the query “192.168.0.1 failed login” will be translated into “arc_{—}1 like ‘192.168.0.1’ and arc_F like ‘failed’ and arc_L like ‘login’”, where a name beginning with “arc_” represents a full-text column name (e.g., an extended field name) within the ESDS 245, and where “like” is a type of clause within a standard database management system (DBMS) query (e.g., SQL). This example corresponds to a hashing scheme that uses a token's first character as the token's hash value.

More complex text operations such as regular expressions can be supported by using any literal initial characters provided by the query (assuming the hashing scheme uses the initial character as the hash value) to eliminate result rows (events) that do not contain candidate terms (i.e., tokens beginning with those characters) and then dropping down into a more conventional regular expression analyzer to examine the remaining candidate rows.

If full-text search features such as word proximity or exact phrase matching (including word sequence/order) are desired, they can be implemented in several ways. The most general way is to use the above technology to narrow down candidate rows (events) and then proceed with the traditional search by retrieving (a greatly reduced set of) candidate rows and processing them normally. The original, unprocessed event description would be accessible either as a value in an additional column or stored externally to the ESDS. If the original, unprocessed event descriptions are stored externally, then the entries in the ESDS will need to somehow indicate with which event descriptions they are associated (e.g., by using the same unique identifier with both the ESDS entry and the associated event description).

In a phrase search, the relative position and co-occurrence of multiple tokens is important. For example, using the string example above, a search for the phrase “lazy dog” should succeed, while a search for the phrase “dog lazy” should fail. One way to implement phrase search is to first perform a token search using the semantics of the Boolean AND operator. So, a search for “lazy dog” and a search for “dog lazy” would yield the same results, namely, a list of events (e.g., rows) that include all of the candidate terms (i.e., “dog” and “lazy”). The candidate events (rows) would then be retrieved. Finally, the retrieved candidate events would be subjected to a search for the precise desired phrase (“lazy dog” or “dog lazy”), thereby eliminating any candidate events that do not match the phrase.

In practice, this implementation of phrase search is effective because the list of candidate events that contain all of the phrase terms individually will typically be a very small subset of the corpus (e.g., all of the events that are stored in the ESDS). Also, the first step (production of the initial small candidate list) can take advantage of a column store implementation and a column search implementation, which are discussed below in conjunction with an exemplary implementation of the ESDS. However, note that the final step (searching events for the precise desired phrase) does not use the column store, since the candidate events have already been retrieved. As a result, the final step is similar to a brute force search, albeit a brute force search over an already optimized subset of the data.

Alternatively, the extended fields can support phrase searches directly. A string is parsed into tokens, and each individual token is stored in an extended field, as described above. In addition to these “standard” tokens, additional tokens are also stored in the extended fields. For example, each pair of tokens that appears in a string is also stored in phrase-order in an appropriate extended field and, therefore, is available for searching. In one embodiment, a token pair includes a first token and a second token that are separated by a special character (e.g., the underscore character “_”). The_character indicates that the first token and the second token appear in the string in that order and are adjacent to each other. Both individual tokens and token pairs can be stored in the extended fields.

The following table shows extended fields and the token pairs that they store from the following string:

A quick brown fox jumped over the lazy dog 3 times at 3:40 am
assuming that the hashing scheme uses the first character of the token as the hash value: (Extended fields that do not store any tokens are omitted in order to save space.)

TABLE 11
Extended fields and tokens

| Extended Field | Token(s) |
|---|---|
| 3 | 3_times |
| A | A_quick, at_3:40 am |
| B | brown_fox |
| D | dog_3 |
| F | fox_jumped |
| J | jumped_over |
| L | lazy_dog |
| O | over_the |
| Q | quick_brown |
| T | the_lazy, times_at |

In this example, the query translation module 240 would translate a phrase query (e.g., “the lazy dog”) into a Boolean query (e.g., “‘the_lazy’ AND ‘lazy_dog’”). Note that the Boolean query is in standard full-text query syntax (just like the phrase query). The translation of the Boolean query from standard full-text query syntax to standard database query syntax would have to occur before the ESDS could be searched.

Note also that just because a string includes the token pairs the_lazy and lazy_dog, that does not necessarily mean that the string also includes the phrase “the lazy dog”. For example, the string could instead include the phrase “the lazy boy and a lazy dog were hungry”. However, the number of such false positives that will need to be removed during the “brute force” stage will typically be much, much smaller compared to the previously-described implementation (which stores only individual tokens and does not store token pairs). The implementation decision regarding whether to store token pairs or not would depend on the importance of the phrase search feature and the tradeoffs in additional complexity and storage overhead versus doing the simpler implementation that stores only individual tokens.

The extended fields can also support “begins with” and “ends with” searches directly. As mentioned above in conjunction with phrase search, a string is parsed into tokens, and each individual token is stored in an extended field, as described above. In addition to these “standard” (i.e., individual) tokens, additional tokens are also stored in the extended fields. These additional tokens use special characters to indicate additional information about the standard tokens, such as whether the standard token is the first token in a string (or in an entire event) or the last token in a string (or in an entire event). One of these additional tokens is equal to a standard token preceded by a first special character (e.g., the caret character [symbol] ). The [symbol] character indicates that the token is the first token within the string (or the entire event). Another of these additional tokens is equal to a standard token followed by a second special character (e.g., the dollar character “$”). The $ character indicates that the token is the last token within the string (or the entire event). Whether the special characters are used to indicate the first/last token in a string (e.g., a value in a particular base field) versus the first/last token in an entire event is configurable. In one embodiment, the special characters [symbol] and $ indicate that a token is the first/last token in a string and/or the first/last token in a sentence (e.g., if a string contains multiple sentences, as indicated by multiple periods).

For example, the string “the quick brown fox” would be parsed into four tokens (the, quick, brown, fox), and each token would be stored in an extended field (“T”, “Q”, “B”, “F”) (assuming the hashing scheme uses the initial character as the hash value). Now, in addition to these four tokens, the following tokens would also be stored in the extended fields: [symbol] the and fox$. The token [symbol] the would have a hash value of [symbol] and be stored in the [symbol] extended field. The token fox$ would have a hash value of “F” and be stored in the “F” extended field. The token [symbol] the” indicates that “the” is the first token in the string. The token “fox$” indicates that “fox” is the last token in the string.

Typically, each individual token would be stored in the appropriate extended field in addition to storing any “search functionality” tokens such as a token pair (using the_character, for phrase searches), a beginning token (using the [symbol] character, for begins with searches), or an ending token (using the $ character, for ends with searches). If the hashing scheme uses the first character as the hash value, then the [symbol] extended field would be examined only when a search is for a token at the beginning of a string (or a token at the beginning of a sentence, if the [symbol] character is pre-pended to a token that follows a period).

These additional tokens, which make use of various special characters, enable the query translation module 240 to translate new types of queries. For example, the query “begins with ‘the’” would be translated into [symbol] the”. The query “ends with ‘fox’” would be translated into “fox$”. The phrase “failed login” would be translated into “failed_login”. The phrase “quick brown fox” would be translated into “‘quick_brown’ AND ‘brown_fox’”.

The storage 210 stores an enhanced structured data store (ESDS) 245. Returning to the example given in the Example section above, a traditional structured data store might store an event using only 4 base fields: a timestamp field, a count field, an incident description field, and an error description field. An ESDS might store the same event using 40 fields: the same 4 base fields and 36 extended fields. The structure of the ESDS is similar to the structure of the traditional structured data store, in that both of them organize data using rows and columns. However, the ESDS supports faster searching of unstructured data because the tokens are stored in the extended fields. The ESDS can be, for example, a relational database or a spreadsheet. An exemplary implementation for the ESDS is described below.

The data store management system 215 includes multiple modules, such as an add data module 250 and a query data module 255. The add data module 250 adds data to the ESDS 245. Specifically, the add data module receives event information in ESDS format (e.g., including both base fields and extended fields) and inserts that event information into the ESDS. The add data module 250 is similar to a standard tool that comes with a traditional structured data store, whether the data store is a relational database or spreadsheet.

The query data module 255 executes a query on the ESDS 245. Specifically, the query data module receives a query in standard database query syntax (e.g., SQL) and executes that query on the ESDS. The query data module 255 is a standard tool that comes with a traditional structured data store, whether the data store is a relational database or spreadsheet.

### Storage

FIG. 3 is a flowchart of a method for storing event information in an enhanced structured data store, according to one embodiment of the invention. In step 310, an event string is received. For example, the control module 220 receives an event string that is to be added to the ESDS 245.

In step 320, an empty event in “ESDS format” is created. For example, the control module 220 creates an empty “row” in ESDS format. “ESDS format” refers to a set of base fields and extended fields, as described above. The exact number of extended fields that are used, and their identities, are determined by the hashing scheme.

In step 330, the event string is parsed into tokens. For example, the control module 220 uses the parsing module 225 to parse the event string into tokens based on delimiters.

Note that steps 320 and 330 can be executed in either order.

In step 340, one or more tokens is mapped to one or more appropriate base fields based on the meanings of the tokens and the schema of the ESDS 245. For example, the control module 220 uses the mapping module 230 to determine to which base field a particular token should be mapped. Appropriate values (e.g., the token values or values derived from the token values) are then stored in the base fields of the ESDS-format event (created in step 320).

In step 350, a portion of the event string that is desired to be indexed (i.e., enabled for faster full-text searching) is identified. The one or more tokens within that portion is mapped to one or more appropriate extended fields based on the values of the tokens and the hashing scheme. For example, the control module 220 uses the hashing module 235 to determine a hash value for a particular token. The token values are then stored in the appropriate extended fields of the ESDS-format event (created in step 320).

Note that steps 340 and 350 can be executed in either order.

In step 360, the ESDS-format event information is stored in the enhanced structured data store (ESDS) 245. For example, the control module 220 uses the add data module 250 to add the ESDS-format event information to the ESDS 245.

When step 360 finishes, the event string that was received has been added to the ESDS 245 in ESDS-format. The event information can now be searched using a faster full-text search. Specifically, the event information that is stored in the extended fields of the ESDS can now be searched using a faster full-text search.

### Search

FIG. 4 is a flowchart of a method for performing a full-text search on event information stored in an enhanced structured data store, according to one embodiment of the invention. When the method 400 begins, event information has already been stored in ESDS 245 in ESDS format, as explained above.

In step 410, a query in standard full-text query syntax is received. For example, the control module 220 receives a query in standard full-text query syntax that is to be executed on the ESDS 245.

In step 420, the query in standard full-text query syntax is translated into a query in standard database query syntax. For example, the control module 220 uses the query translation module 240 to translate the query in standard full-text query syntax into a query in standard database query syntax.

In step 430, the query in standard database query syntax is executed on the ESDS 245. For example, the control module 220 uses the query data module 255 to execute the query in standard database query syntax on the ESDS 245.

In step 440, the query results are returned. For example, the control module 220 receives query results from the query data module 255 and returns those results.

### ESDS—Exemplary Implementation

The techniques described above (e.g., storing tokens in extended fields based on their values and a hashing scheme) can be used with any structured data store. For example, the technique can be used with the row-based DBMS described in U.S. patent application Ser. No. 11/966,078, entitled “Storing Log Data Efficiently While Supporting Querying to Assist in Computer Network Security,” filed Dec. 28, 2007.

The technique is particularly well suited to a column-based DBMS such as the column-based DBMS and/or the row-and-column-based DBMS described in U.S. patent application Ser. No. 12/554,541, entitled “Storing Log Data Efficiently While Supporting Querying,” filed Sep. 4, 2009 (“the '541 Application”). A column-based DBMS is advantageous because the technique narrows a query down to a specific column (extended field) that must contain a given search term (even though the end user does not specify a column at all). The other fields of the rows need not be examined (or even loaded) in order to determine a result.

The '541 Application describes a logging system that stores events using only column-based chunks or a combination of column-based chunks and row-based chunks. A column-based chunk represents a set of values of one field (column) over multiple events. If the column is one of the extended columns described above, then the values represented by the column-based chunk will be tokens (from various events) that were mapped to a particular column. For example, a column-based chunk that is associated with the “A” column will represent tokens that start with the letter “A” (assuming the hashing scheme uses the initial character as the hash value).

One way to implement a column-based chunk is to list each token represented by the chunk (e.g., each token that starts with the letter “A” that was contained in the various events). The tokens can be ordered based on their associated events (e.g., based on a unique identifier for each event).

All tokens within the same column-based chunk will share some characteristic based on the hashing scheme used. For example, all tokens will share the same initial character if the hashing scheme uses the initial character as the hash value. Beyond this similarity, the statistical distribution of the token values can vary.

If the statistical distribution of a column-based chunk's token values is characterized by a low cardinality (fewer distinct token values) and a high ordinality (more repeated instances of tokens with the same values), then it is possible to implement the column-based chunk in an optimized (compressed) way. In one embodiment, a column-based chunk is implemented using one dictionary, one or more vectors, and one or more counts.

The dictionary is a list of unique token values contained in that chunk. The token values can be listed in sorted order so that a determination that a query term is not a match can be made as soon as a lexically higher token has been encountered. One vector is included for each dictionary entry and lists a unique identifier for each event that contains the dictionary entry token. One count is included for each dictionary entry and indicates the number of events that contain the dictionary entry token (which is also equal to the number of entries in the vector). The count is useful because a lower count means that the associated token value is more discriminatory (more useful) when performing a search. If a statistical distribution of token values has a low cardinality and a high ordinality, then the associated column-based chunk would have fewer dictionary entries and higher counts.

For example, consider a “C” extended column in an ESDS where the hashing scheme uses the first character as the hash value. In Table, 1, the column entitled “Token” represents the “C” extended column. Adjacent to each token is the unique identifier for the event from which the token was parsed.

TABLE 1
Tokens and event identifiers

| Token | Event Identifier |
|---|---|
| cat | 0 |
| cut | 1 |
| can | 2 |
| cap | 3 |
| cut | 4 |
| can | 5 |
| cat | 6 |
| cat | 7 |
| cut | 8 |
| cat | 9 |
| cat | 10 |

The column-based chunk for this “C” extended column can be implemented in an optimized (compressed) way using one dictionary, four counts, and four vectors. The dictionary entries would be {can, cap, cat, cut}. The count and the vector for each dictionary entry would be:

TABLE 2
Dictionary entries, counts, and vectors

| Entry | Count | Vector |
|---|---|---|
| can | 2 | 2, 5 |
| cap | 1 | 3 |
| cat | 5 | 0, 6, 7, 9, 10 |
| cut | 3 | 1, 4, 8 |

Some tokens rarely repeat themselves across events, which makes it difficult to implement a column-based chunk in a compressed fashion. For example, consider an event that contains a Uniform Resource Locator (URL) that represents a website visited by a user. If that website is rarely visited (by either the same user or other users), then the URL will rarely be repeated within a column-based chunk. In one embodiment, to address this situation, a URL is not stored as one single token. Instead, a URL is parsed into multiple tokens based on delimiters. For example, the URL “http://www.yahoo.com/weather?95014” is parsed into 6 tokens: “http”, “www”, “yahoo”, “com”, “weather”, and “95014”. The “http” token, “www” token, and “com” token will frequently repeat themselves across events, making it easy to store them in a compressed fashion. The “yahoo” token will also repeat itself, although less frequently. The “weather” token and “95014” token will repeat themselves the least frequently.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A computer-implemented method for storing information in an entry within a structured data store, wherein the entry includes one or more base fields and one or more extended fields, comprising:
receiving a string;
extracting information from the string;
storing the extracted information in the one or more base fields of the entry based on the meaning of the extracted information;
identifying a portion of the string that is to be enabled for faster searching;
parsing the identified portion of the string into a plurality of tokens; and
for each token in the plurality of tokens:
determining a hash value of the token based on a hashing scheme; and
storing the token in an extended field that corresponds to the determined hash value.

2. The method of claim 1, wherein the identified portion of the string comprises the entire string.

3. The method of claim 1, wherein the identified portion of the string is a value stored in a base field.

4. The method of claim 1, wherein the hash value of the token comprises a character.

5. The method of claim 1, wherein the hashing scheme comprises using the first character of the token as the token's hash value.

6. The method of claim 1, wherein the hash value of the token comprises a number.

7. The method of claim 1, wherein the hashing scheme comprises using the number of characters within the token as the token's hash value.

8. The method of claim 1, wherein the hashing scheme comprises using both the first character of the token and the number of characters within the token as the token's hash value.

9. The method of claim 1, further comprising:
for each token in the plurality of tokens:
generating a token pair that comprises the token and a second token that immediately follows the token within the identified portion of the string;
determining a hash value of the token pair based on a hashing scheme; and
storing the token pair in an extended field that corresponds to the determined hash value.

10. The method of claim 1, further comprising:
for each token in the plurality of tokens:
if the token is the first token within the identified portion of the string:
generating a beginning token that comprises a special character and the token, wherein the special character indicates that the token is the first token within the identified portion of the string;
determining a hash value of the beginning token based on a hashing scheme; and
storing the beginning token in an extended field that corresponds to the determined hash value.

11. The method of claim 1, further comprising:
for each token in the plurality of tokens:
if the token is the last token within the identified portion of the string:
generating an ending token that comprises the token and a special character, wherein the special character indicates that the token is the last token within the identified portion of the string;
determining a hash value of the ending token based on a hashing scheme; and
storing the ending token in an extended field that corresponds to the determined hash value.

12. A computer program product for storing information in an entry within a structured data store, wherein the entry includes one or more base fields and one or more extended fields, and wherein the computer program product is stored on a computer-readable medium that includes instructions that, when loaded into memory, cause a processor to perform a method, the method comprising:
receiving a string;
extracting information from the string;
storing the extracted information in the one or more base fields of the entry based on the meaning of the extracted information;
identifying a portion of the string that is to be enabled for faster searching;
parsing the identified portion of the string into a plurality of tokens; and
for each token in the plurality of tokens:
determining a hash value of the token based on a hashing scheme; and
storing the token in an extended field that corresponds to the determined hash value.

13. A system for storing information in an entry within a structured data store, wherein the entry includes one or more base fields and one or more extended fields, the system comprising:
a computer-readable medium that includes instructions that, when loaded into memory, cause a processor to perform a method, the method comprising:
receiving a string;
extracting information from the string;
storing the extracted information in the one or more base fields of the entry based on the meaning of the extracted information;
identifying a portion of the string that is to be enabled for faster searching;
parsing the identified portion of the string into a plurality of tokens; and
for each token in the plurality of tokens:
determining a hash value of the token based on a hashing scheme; and
storing the token in an extended field that corresponds to the determined hash value; and
a processor for performing the method.
